(19) United States
(12) Patent Application Publication
(10) Pub. No.: US 2017/0132978 A1
(43) Pub. Date: May 11, 2017

(54) DISPLAY DEVICE AND DRIVING METHOD FOR THE SAME

(71) Applicant: Shenzhen China Star Optoelectronics Technology Co., Ltd., Shenzhen, Guangdong (CN)

(72) Inventors: Jianhang FU, Shenzhen, Guangdong (CN); Tai-jiun HWANG, Shenzhen, Guangdong (CN)

(21) Appl. No.: 14/760,737

(22) PCT Filed: Jun. 5, 2015
(86) PCT No.: PCT/CN2015/080876

§ 371 Date: Jul. 14, 2015

(30) Foreign Application Priority Data
May 21, 2015 (CN) 201510263004.3

(51) Int. Cl. G09G 3/3275; G09G 3/3233; G09G 3/3266

(52) U.S. Cl. CPC G09G 3/3275; G09G 3/3266; G09G 3/3233; G09G 2310/0272; G09G 2300/0439; G09G 2320/043

(57) ABSTRACT

A display device includes a format converter and a display panel. The format converter is for obtaining an original data frame, and performing a format conversion for the original data frame in order to obtain multiple converted data frames having different formats. The display panel is for that when obtaining each converted data frame which is converted through the format converter, one portion of pixel units of the display panel emits light, and the other portion of the pixel units of the display panel does not emit light. A driving method for a display device is also disclosed. The present invention can reduce the light emitting time of the pixel units of the display panel, and effectively decrease the aging speed of the display panel.

### BACKGROUND OF THE INVENTION

1. Field of the Invention

The present invention relates to a liquid crystal display field, and more particularly to a display device and a driving method for the same. 2. Description of Related Art

With the development of technology, a display device has been popular in public life. The current trend of the display device is an OLED (Organic Light-Emitting Diode, or organic laser display) display device. The display panel of the OLED display device is driven by a direct current. Holes and electrons respectively enter a light emitting layer from a positive electrode and a negative electrode. Then, the holes and the electrons are combined in the light emitting layer to emit light. As shown in FIG. 1, FIG. 1 is a schematic diagram of a sub-pixel structure of an OLED display device in the conventional art. In the current structure of the sub-pixel of the OLED display device, when a signal line “a” of the sub-pixel is turned on, a data line “b” charges the capacitor C. The voltage of the capacitor C functions as a gate voltage of a second driving switch T2 in order to control a current flowing through the display panel. When the display panel is operating, all pixels continue to emit light.

However, with the increased use of time, some of the holes and electrons are accumulated at interfaces of transmission layers and the light emitting layer respectively so as to form an internal electric field inside the display panel. As a result, a threshold current flowing through the display panel is increased, the brightness is decreased, and the aging speed of the display panel is accelerated.

According, a display device and a driving method for the same are required to solve the above problems.

### SUMMARY OF THE INVENTION

The main technology problem solved by the present invention is to provide a display device and a driving method, which can decrease the aging speed of the display panel.

In order to solve the above problems, a technology solution adopted by the present invention is: a display device, comprising: a format converter for obtaining an original data frame, and performing a format conversion for the original data frame in order to obtain multiple converted data frames having different formats; a display panel for that when obtaining each converted data frame which is converted through the format converter, one portion of pixel units of the display panel emits light, and the other portion of the pixel units of the display panel does not emit light.

Wherein, the display device further comprises: a scanning driver, connected with the display panel, and for performing a signal scanning for the display panel; and a data driver, respectively connected with the format converter and the display panel, for driving the pixel units of the display panel to emit light after obtaining each converted data frame from the format converter such that one portion of the pixel units of the display panel emits light, and the other portion of the pixel units of the display panel does not emit light.

Wherein, the format converter includes: an acquisition module for obtaining the original data frame; a conversion module having at least two conversion units, and for performing a format conversion to the original data frame through the at least two conversion units in order to obtain the multiple converted data frames having different formats.

Wherein, the format converter further comprises: a control module, used for controlling the conversion module to select one of the at least two conversion units to perform the format conversion to the original data frame.

Wherein, when the display panel obtains each converted data frame through the format converter, one half of the pixel units emits light, and the other half of the pixel units does not emit light.

Wherein, when the display panel obtains each converted data frame through the format converter, each pixel unit which emits light is adjacent to each pixel unit which does not emit light.

Wherein, a number of the converted data frames which are required for all of the pixel units of the display panel to emit light is the same as a number of the conversion units disposed in the conversion module.

In order to solve the above problems, another technology solution solved by the present invention is: a driving method for a display device, wherein, the display device includes a format converter and a display panel, and the method comprises: obtaining an original data frame, and performing a format conversion for the original data frame in order to obtain multiple converted data frames having different formats by the format converter; and when obtaining each converted data frame which is converted through the format converter by the display panel, driving one portion of pixel units of the display panel to emit light, and the other portion of the pixel units of the display panel to not emit light.

Wherein, the format converter is provided with at least two conversion units, and a step of obtaining an original data frame, and performing a format conversion for the original data frame in order to obtain multiple converted data frames having different formats by the format converter includes: obtaining the original data frame by the format converter; selecting one of the at least two conversion units by the format converter; and performing the format conversion for the original data frame in order to obtain the converted data frame having a different format by the format converter through the one of the at least two conversion units.

Wherein, a step of driving one portion of pixel units of the display panel to emit light, and the other portion of the pixel units of the display panel to not emit light includes: driving one half of the pixel units to emit light, and the other half of the pixel units to not emit light.

Wherein, the step of driving one portion of pixel units of the display panel to emit light, and the other portion of the pixel units of the display panel to not emit light includes: each pixel unit which emits light is adjacent to each pixel unit which does not emit light.

The beneficial effect of the present invention is: comparing to the conventional art, the display device of the present invention includes a format converter and a display panel. The format converter is for obtaining an original data frame, and performing a format conversion for the original data frame in order to obtain multiple converted data frame having different formats. The display panel is for that when obtaining a converted data frame which is converted through the format converter, one portion of pixel units of the display panel emits light, and the other portion of the pixel units of the display panel does not emit light. Through above method, the present invention performs a format conversion to an original data frame in order to control that when the display panel obtains each converted data frame, one portion of pixel units of the display panel emits light, and the other portion of the pixel units of the display panel does not emit light. Accordingly, the present invention can reduce the light emitting time of the pixel units of the display panel, and effectively decrease the aging speed of the display panel.

### BRIEF DESCRIPTION OF THE DRAWINGS

FIG. 1 is a schematic diagram of a sub-pixel structure of an OLED display device in the conventional art;

FIG. 2 is a schematic diagram of a display device according to the present invention;

FIG. 3 is a format converter shown in FIG. 1;

FIG. 4 is a first display method of a pixel unit of a display panel according to the present embodiment;

FIG. 5 is a second display method of a pixel unit of a display panel according to the present embodiment;

FIG. 6 is a flow chart of a driving method of the display device according to the present embodiment; and

FIG. 7 is a flow chart of sub-steps of step S101 shown in FIG. 6.

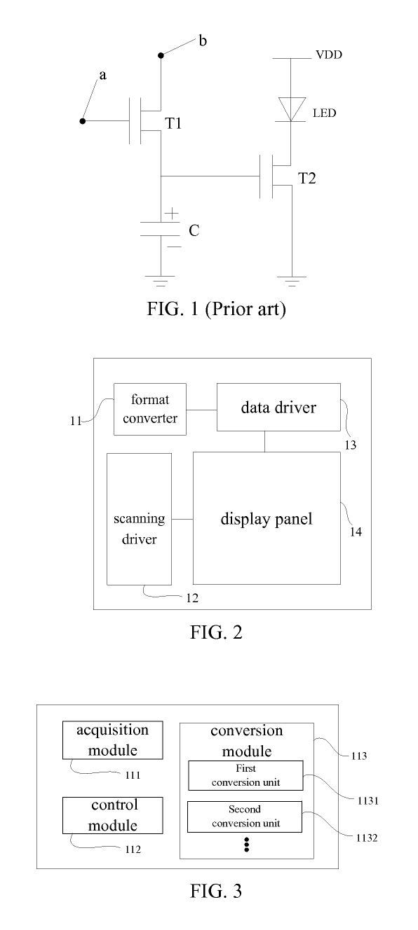

### DETAILED DESCRIPTION OF THE PREFERRED EMBODIMENT

The following content combines figures and embodiments for detail description of the present invention.

The present invention discloses a display device. Preferably, the display device is an OLED display device. Of course, the present invention is not limited to the OLED display device. In another embodiment, the display device can also be other types of display devices.

With reference to FIG. 2, FIG. 2 is a schematic diagram of a display device according to the present invention. The display device includes a format converter 11, a scanning driver 12, a data driver 13, and a display panel 14.

The format converter 11 is used for obtaining each original data frame and performing a format conversion to each original data frame into multiple converted data frame having different formats. In the present embodiment, the format converter 11 is disposed in a timing controller (also known as TCON for person skilled in the art). When the timing controller provides a timing control signal to the scanning driver 12 and the data driver 13 of the display panel 14, the format converter 11 converts performs the format conversion to the original data frame. In another embodiment, the format converter 11 can also be disposed independently in the display device.

With reference to FIG. 3, the format converter 11 includes an acquisition module 111, a control module 112, and a conversion module 113. The acquisition module 111 is used for obtaining each original data frame. The conversion module 113 is provided with at least two conversion units. Specifically, the conversion module 113 may include a first conversion unit 1131, a second conversion unit 1132, a third conversion unit or more conversion units. The conversion module 113 is used for performing the format conversion to the original data frame through the at least two conversion units in order to obtain multiple converted data frames having different formats. The control module 112 is used for controlling the conversion module 113 to select one of the at least two conversion units to perform the format conversion to the original data frame.

In the present embodiment, the control module 112 control the conversion module 113 to sequentially select one of the at least two conversion units to perform the format conversion to the original data frame. Specifically, when the acquisition module 111 obtains a first original data frame, the control module 112 control the conversion module 113 to select the first conversion unit 1131 to perform the format conversion to the original data frame. When the acquisition module 111 obtains a second original data frame, the control module 112 controls the conversion module 113 to select the second conversion unit 1132 to perform the format conversion to the original data frame. When the acquisition module 111 obtains a third original data frame, the control module 112 control the conversion module 113 to select the third conversion unit to perform a format conversion to the third original data frame, and so on.

Of course, in another embodiment, the control module 112 can control the conversion module 113 to not sequentially select one of the at least two conversion units to perform a format conversion to the original data frame. Specifically, when the acquisition module 111 obtains a first original data frame, the control module 112 control the conversion module 113 to select the second conversion unit 1132 to perform a format conversion to an original data of the first original data frame. When the acquisition module 111 obtains a second original data frame, the control module 112 controls the conversion module 113 to select the first conversion unit 1131 to perform a format conversion to an original data of the second original data frame. When the acquisition module 111 obtains a third original data frame, the control module 112 control the conversion module 113 to select a third conversion unit to perform a format conversion to an original data of the third original data frame, and so on.

The control module 112 controls the conversion module 113 to select a conversion unit to perform a format conversion for the original data according to a variable flag. Specifically, when the variable flag is a first value, the control module 112 controls the conversion module 113 to select the first conversion unit 1131 to perform a format conversion for the original data. When the variable flag is a second value, the control module 112 controls the conversion module 113 to select the second conversion unit 1132 to perform a format conversion for the original data. When the variable flag is a third value, the control module 112 control the conversion module 113 to select the third conversion unit to perform a format conversion for the original data.

The scanning driver 12 is connected with the display panel for performing a signal scanning to the display panel 14.

The data driver 13 is respectively connected with the format converter 11 and the display panel 14 for driving pixel units of the display panel 14 to emit light after receiving a converted data frame from the format converter 11.

When the display panel 14 receives a converted data frame which is converted by the format converter 11, one portion of the pixel units of the display panel 14 emits light, and the other portion of the pixel units of the display panel 14 does not emit light. In a normal condition, each pixel unit includes three sub-pixel units.

For illustrating the present invention better, the present embodiment utilizes the conversion module 113 including the first conversion unit 1131 and the second conversion unit 1132 as an example. When the display panel 14 obtains a first converted data frame through the first conversion unit 1131, one portion of the pixel units of the display panel 14 emit light, and the other portion of the pixel units of the display panel 14 does not emit light. When the display panel 14 obtains a second converted data frame through the second conversion unit 1132, the one portion of the pixel units of the display panel 14 does not emit light, and the other portion of the pixel units of the display panel 14 emit light. That is, the display panel 14 is required to obtain two converted data frames, then, all of the pixel units of the display panel 14 can emit light.

In the present embodiment, in order to not affect the display effect of the display panel 14, when the display panel 14 obtain a converted data frame through the format converter 11, one half of the pixel units of the display panel 14 emits light, and the other half of the pixel units of the display panel 14 does not emit light. Preferably, in order to make the pixel units of the display panel 14 to evenly emit light, in the condition that when the display panel 14 obtains a converted data frame through the format converter 11, one half of the pixel units of the display panel 14 emits light, and the other half of the pixel units of the display panel 14 does not emit light, each pixel unit of the display panel 14 which emit light is adjacent to each pixel unit of the display panel 14 which does not emit light.

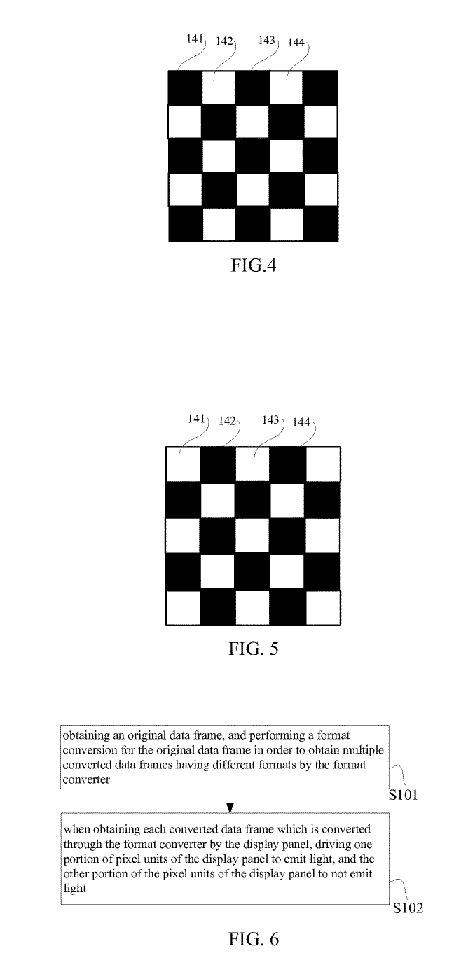

Specifically, with reference to FIG. 4 and FIG. 5, and using a first pixel unit 141, a second pixel unit 142, a third pixel unit 143 and a fourth pixel unit 144 as an example. When the display panel 14 obtains a first converted data frame which is converted through a first conversion unit, the first pixel unit 141 and the third pixel unit 143 does not emit light, and the second pixel unit 142 and the fourth pixel unit 144 of the display panel 14 emit light (as shown in FIG. 4). When the display panel 14 obtains a second converted data frame which is converted through a second conversion unit 1132, the first pixel unit 141 and the third pixel unit 143 of the display panel 14 emit light, and the second 142 and the fourth unit 144 of the display panel 14 does not emit light (as shown in FIG. 5)

In another embodiment, for further decreasing the aging speed of the display panel 14, the conversion module 113 can also include a first conversion unit 1131, a second conversion unit 1132 and a third conversion unit. When the display panel 14 obtains each converted data frame which is converted through the format converter, one third of the pixel units of the display panel 14 emit light, and remaining two third of the pixel units of the display panel 14 does not emit light.

That is, the display panel 14 is required to obtain three converted data frames so that all of the pixel units of the display panel 14 can emit light. Specifically, when the display panel 14 obtains a first converted data frame which is converted through a first conversion unit 1131, one third of the pixel units of the display panel 14 emits light. When the display panel 14 obtains a second converted data frame which is converted through a second conversion unit 1132, another one third of the pixel units of the display panel 14 emits light. When the display panel 14 obtains a third converted data frame which is converted through a third conversion unit, the remaining one third of the pixel units of the display panel 14 emits light. Accordingly, the light emitting time of the pixel units of the display panel 14 is decreased.

That is, the number of the converted data frames required for all of the pixel units of the display panel 14 to emit light is the same as the number of the conversion units disposed in the conversion module 113. That is, the display panel 14 is required to obtain the converted data frames which have the same number as the conversion units disposed in the conversion module to make all of the pixel units of the display panel 14 to emit light. For example, if the conversion module 113 includes 4, 5, 6, 7 conversion units, the display panel 14 is required to obtain 4, 5, 6, 7 converted data frames so that all of the pixel units of the display panel 14 can emit light.

In another embodiment, the present invention is not limited that the display panel 14 is required to obtain the converted data frames which have the same number as the conversion units so that all of the pixel units of the display panel 14 can emit light. More converted data frames can be selected to make all of the pixel units of the display panel 14 to emit light according to an actual requirement. Specifically, the conversion module 113 can only include a first conversion unit 1131 and a second conversion unit 1132. When the format converter 11 obtains a first original data frame, the format converter 11 utilizes the first conversion unit 1131 to convert the first original data frame such that one portion of the pixel units of the display panel 14 emits light, and the other portion of the pixel units of the display panel 14 does not emit light. When the format converter 11 obtains a second original data frame, the format converter 11 utilizes the first conversion unit 1131 to convert the second original data frame such that one portion of the pixel units of the display panel 14 emits light, and the other portion of the pixel units of the display panel 14 does not emit light. When the format converter 11 obtains a third original data frame, the format converter 11 utilizes the second conversion unit 1132 to convert the third original data frame such that one portion of the pixel units of the display panel 14 emits light, and the other portion of the pixel units of the display panel 14 does not emit light.

In the present invention, under the premise of not changing the structure of the pixel unit, each original data frame is converted. An original picture data corresponding to the original data frame is inputted to the display panel 14 for displaying after being converted. Besides, only a portion of the pixel units on each converted data frame emits light. All of the pixel units are displayed alternately such that the operation time of the display panel 14 for each converted data frame is shorten in the same operation time of the display panel 14.

Furthermore, as shown in FIG. 6, and FIG. 6 is a flow chart of a driving method of the display device according to the present embodiment. The method in FIG. 5 corresponds to the display device shown in FIG. 2. The method comprises the following steps:

Step S101: obtaining an original data frame, and performing a format conversion for the original data frame in order to obtain multiple converted data frames having different formats by the format converter 11.

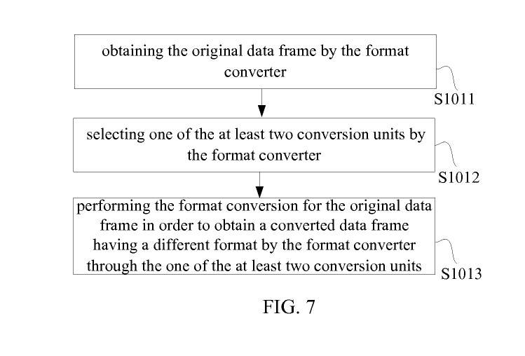

As shown in FIG. 7, and FIG. 7 is a flow chart of sub-steps of step S101 shown in FIG. 6. The sub-steps include:

Step S1011: obtaining the original data frame by the format converter 11;

Step S1012: selecting one of the at least two conversion units by the format converter 11.

In the step S1012, the format converter 11 can sequentially select one of the at least two conversion units, or not sequentially select one of the at least two conversion units.

Step S1013: performing the format conversion for the original data frame in order to obtain a converted data frame having a different format by the format converter 11 through the one of the at least two conversion units.

Step S102: when obtaining each converted data frame which is converted through the format converter 11 by the display panel 14, driving one portion of pixel units of the display panel 14 to emit light, and the other portion of the pixel units of the display panel 14 to not emit light.

In the present embodiment, the number of the converted data frames required for all of the pixel units of the display panel 14 to emit light is the same as the number of the conversion units in the conversion module 113. That is, the display panel 14 is required to obtain the converted data frames which have the same number as the conversion units disposed in the conversion module 113 to make all of the pixel units of the display panel 14 to emit light. For example, if the conversion module 113 includes 2, 3, 4, 5, 6, 7 conversion units, the display panel 14 is required to obtain 2, 3, 4, 5, 6, 7 converted data frames so that all of the pixel units of the display panel 14 can emit light.

The present embodiment utilizes the conversion module 113 including the first conversion unit 1131 and the second conversion unit 1132 as an example. The display panel 14 is required to obtain two converted data frames such that all of the pixel units of the display panel 14 can emit light. Specifically, when the display panel 14 obtains a first converted data frame through the first conversion unit 1131, one portion of the pixel units of the display panel 14 emit light, and the other portion of the pixel units of the display panel 14 does not emit light. When the display panel 14 obtains a second converted data frame through the second conversion unit 1132, the one portion of the pixel units of the display panel does not emit light, and the other portion of the pixel units of the display panel 14 emit light.

In the step S102, in order to not affect the display effect of the display panel 14, when the display panel 14 obtains a converted data frame through the format converter 11, one half of the pixel units of the display panel 14 emits light, and the other half of the pixel units of the display panel 14 does not emit light. Preferably, in order to make the pixel units of the display panel 14 to evenly emit light, in the condition that when the display panel obtains a converted data frame through the format converter 11, one half of the pixel units of the display panel 14 emits light, and the other half of the pixel units of the display panel 14 does not emit light, each pixel unit of the display panel 14 which emits light is adjacent to each pixel unit of the display panel 14 which does not emit light.

In another embodiment, for further decreasing the aging speed of the display panel 14, the conversion module 113 can also include a first conversion unit 1131, a second conversion unit 1132 and a third conversion unit. When the display panel 14 obtains each converted data frame which is converted through the format converter, one third of the pixel units of the display panel 14 emit light, and remaining two third of the pixel units of the display panel 14 does not emit light. That is, the display panel 14 is required to obtain three converted data frames such that all of the pixel units of the display panel 14 can emit light.

In another embodiment, the present invention is not limited that the display panel 14 is required to obtain the converted data frames which have the same number as the conversion units so that all of the pixel units of the display panel 14 can emit light. More converted data frames can be selected to make all of the pixel units of the display panel 14 to emit light according to an actual requirement. For example, the number of the converted data frames required for all of the pixel units of the display panel 14 to emit light is not the same as the number of the conversion units disposed in the conversion module 113

In summary, the display device of the present invention includes a format converter and a display panel. The format converter is for obtaining an original data frame, and performing a format conversion for the original data frame in order to obtain multiple converted data frame having different formats. The display panel is for that when obtaining a converted data frame which is converted through the format converter, one portion of pixel units of the display panel emits light, and the other portion of the pixel units of the display panel does not emit light.

Through above method, the present invention performs a format conversion to an original data frame in order to control that when the display panel obtains each converted data frame, one portion of pixel units of the display panel emits light, and the other portion of the pixel units of the display panel does not emit light. Accordingly, the present invention can reduce the light emitting time of the pixel units of the display panel, and effectively decrease the aging speed of the display panel.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A display device, comprising:
a format converter for obtaining an original data frame, and performing a format conversion for the original data frame in order to obtain multiple converted data frame having different formats;
a display panel for that when obtaining a converted data frame which is converted through the format converter, one portion of pixel units of the display panel emits light, and the other portion of the pixel units of the display panel does not emit light;
a scanning driver, connected with the display panel, and for performing a signal scanning for the display panel; and
a data driver, respectively connected with the format converter and the display panel, for driving the pixel units of the display panel to emit light after obtaining the converted data frame from the format converter such that one portion of pixel units of the display panel emits light, and the other portion of the pixel units of the display panel does not emit light;
wherein, the format converter includes:
an acquisition module for obtaining the original data frame; and
a conversion module having at least two conversion units, and for performing a format conversion to the original data frame through the at least two conversion units in order to obtain the multiple converted data frames having different formats.

2. The display device according to claim 1, wherein, the format converter further comprises:
a control module, used for controlling the conversion module to select one of the at least two conversion units to perform the format conversion to the original data frame.

3. The display device according to claim 2, wherein, the control module controls the conversion module to sequentially select one of the at least two conversion units to perform the format conversion to the original data frame.

4. The display device according to claim 1, wherein, when the display panel obtains each converted data frame through the format converter, one half of the pixel units emits light, and the other half of the pixel units does not emit light.

5. The display device according to claim 4, wherein, when the display panel obtains each converted data frame through the format converter, each pixel unit which emits light is adjacent to each pixel unit which does not emit light.

6. The display device according to claim 1, wherein, a number of the converted data frames which are required for all of the pixel units of the display panel to emit light is the same as a number of the conversion units disposed in the conversion module.

7. A display device, comprising:
a format converter for obtaining an original data frame, and performing a format conversion for the original data frame in order to obtain multiple converted data frames having different formats; and
a display panel for that when obtaining each converted data frame which is converted through the format converter, one portion of pixel units of the display panel emits light, and the other portion of the pixel units of the display panel does not emit light.

8. The display device according to claim 7, wherein, the display device further comprises:
a scanning driver, connected with the display panel, and for performing a signal scanning for the display panel; and
a data driver, respectively connected with the format converter and the display panel, for driving the pixel units of the display panel to emit light after obtaining each converted data frame from the format converter such that one portion of the pixel units of the display panel emits light, and the other portion of the pixel units of the display panel does not emit light.

9. The display device according to claim 7, wherein, the format converter includes:
an acquisition module for obtaining the original data frame; and
a conversion module having at least two conversion units, and for performing a format conversion to the original data frame through the at least two conversion units in order to obtain the multiple converted data frames having different formats.

10. The display device according to claim 9, wherein, the format converter further comprises:
a control module, used for controlling the conversion module to select one of the at least two conversion units to perform the format conversion to the original data frame.

11. The display device according to claim 7, wherein, when the display panel obtains each converted data frame through the format converter, one half of the pixel units emits light, and the other half of the pixel units does not emit light.

12. The display device according to claim 11, wherein, when the display panel obtains each converted data frame through the format converter, each pixel unit which emits light is adjacent to each pixel unit which does not emit light.

13. A driving method for a display device, wherein, the display device includes a format converter and a display panel, and the method comprises:
obtaining an original data frame, and performing a format conversion for the original data frame in order to obtain multiple converted data frames having different formats by the format converter; and
when obtaining each converted data frame which is converted through the format converter by the display panel, driving one portion of pixel units of the display panel to emit light, and the other portion of the pixel units of the display panel to not emit light.

14. The driving method according to claim 13, wherein, the format converter is provided with at least two conversion units, and a step of obtaining an original data frame, and performing a format conversion for the original data frame in order to obtain multiple converted data frames having different formats by the format converter includes:
obtaining the original data frame by the format converter;
selecting one of the at least two conversion units by the format converter; and
performing the format conversion for the original data frame in order to obtain the converted data frame having a different format by the format converter through the one of the at least two conversion units.

15. The driving method according to claim 13, wherein, a step of driving one portion of pixel units of the display panel to emit light, and the other portion of the pixel units of the display panel to not emit light includes:
driving one half of the pixel units to emit light, and the other half of the pixel units to not emit light.

16. The driving method according to claim 15, wherein, the step of driving one portion of pixel units of the display panel to emit light, and the other portion of the pixel units of the display panel to not emit light includes:
each pixel unit which emits light is adjacent to each pixel unit which does not emit light.
